(19) United States
(12) Patent Application Publication
(10) Pub. No.: US 2009/0155667 A1
(43) Pub. Date: Jun. 18, 2009

(54) Bipolar plate and process for producing a protective layer on a bipolar plate

(75) Inventor: Thomas Kiefer, Ettlingen (DE)

Correspondence Address: Edward J. Timmer, P.O. Box 770, Richland, MI, 49083, US

(73) Assignee: ElringKlinger AG

(21) Appl. No.: 12/079,558

(22) Filed: Mar. 27, 2008

Related U.S. Application Data
(63) Continuation of application No. PCT/EP2007/011021, filed on Dec. 14, 2007.

(51) Int. Cl. H01M 2/00; B05D 5/12

(52) U.S. Cl. 429/34; 427/115

(57) ABSTRACT

In order to provide a bipolar plate for a fuel cell unit, wherein the bipolar plate comprises a support layer and a protective layer, wherein the protective layer comprises an at least binary oxide system with at least two different types of metal cations, the protective layer of which reliably reduces chromium evaporation even in long-term operation and which also meets the other requirements set for a bipolar plate, it is proposed that one type of metal cation of the oxide system of the protective layer is Fe.

### RELATED APPLICATION

This application is a continuation application of PCT/EP2007/011021 filed Dec. 14, 2007, the entire specification of which is incorporated herein by reference.

### FIELD OF DISCLOSURE

The present invention relates to a bipolar plate for a fuel cell unit, wherein the bipolar plate comprises a support layer and a protective layer, wherein the protective layer comprises an at least binary oxide system with at least two different types of metal cations.

### BACKGROUND

Since a fuel cell unit only has a low single cell voltage of approximately 0.4 volts to approximately 1.2 volts (depending on load), a series connection of a plurality of electrochemical cells in a fuel cell stack is necessary, as a result of which the output voltage is scaled to a range of interest from an applications viewpoint. For this, the individual electrochemical cells are connected by means of so-called bipolar plates (also referred to as interconnectors).

Such a bipolar plate must meet the following requirements:
Distribution of the media (fuel gas and/or oxidising agents).
Adequate electrical conductivity, since within the fuel cell unit the electrons generated on the hydrogen side (anode) are directed through the bipolar plates in order to be available to the air side (cathode) of the next electrochemical cell. To keep the electrical losses low here, the material for the bipolar plates must have an adequately high electrical conductivity.
Adequate corrosion resistance, since the typical operating conditions of a fuel cell unit (operating temperature approximately 800° C., oxidising/reducing atmosphere, moist air) have a corrosive effect. For this reason, high requirements are set for the corrosion resistance of the material of the bipolar plate.

Ferritic, chromium oxide-forming special steels are usually used as material for the bipolar plates of high-temperature fuel cells. One reason for this is the relatively good electrical conductivity of the self-forming chromium oxide layer compared to the insulating oxide layers, which are configured from other high-temperature steels or alloys (e.g. aluminium oxide or silicon oxide forming agents).

In the case of a temperature increase, chromium oxide forms on the surface of a chromium oxide-forming special steel. Volatile chromium compounds are formed from this chromium oxide under the operating conditions of a fuel cell. In particular in the long-term operation of the fuel cell unit, this “chromium evaporation” results in a poisoning of the cathode, which causes a drastic reduction in the current efficiency.

To prevent the chromium evaporation it has already been proposed to dope specific elements (e.g. Mn, Ni, Co) into the steel of the bipolar plate, which influence growth of the oxide layer and convert the originally formed chromium oxide into a more chemically stable form. While a minimisation of the chromium evaporation can be achieved as a result of such alloy additions, no lasting protection of the cathode is provided.

Moreover, it has already been proposed to coat the bipolar plates with oxides or oxide mixtures (e.g. oxides of Mn, Co, Cu). These layers are compacted as a result of solid-state diffusion by a subsequent thermal treatment. Tests have shown that Mn, Fe and Cr diffuse from the steel of the bipolar plate into such a protective layer and thus assure compaction.

However, as a result of diffusion processes, the compacted protective layer also contains chromium. Thus, the possibility of a chromium evaporation that is associated with an increased degradation of the cathode continues to exist.

A further bipolar plate with protective layer is known from the article by Zhenguo Yang, Guanguang Xia and Jeffry W. Stevenson: “Mn_{1.5}Co_{1.5}O₄ Spinel Protection Layers on Ferritic Stainless Steels for SOFC Interconnect Applications”, published in Electrochemical and Solid-State Letters, Volume 8 (3), pages A 168 to A 170 (2005).

In the production of the bipolar plate known from this publication a protective layer is generated by a sintering process of an oxide layer (Mn_{1.5}Co_{1.5}O₄) applied by a wet-chemical method in a reducing atmosphere. In this process a paste containing a binder and oxides of the nominal composition Mn_{1.5}Co_{1.5}O₄ is applied to a steel material. The sintering occurs in two separate thermal treatment steps. In the first temperature cycle the lattice structure of the protective layer is weakened by a reduction in the oxygen partial pressure, as a result of which an improved sintering behaviour is achieved. In a separate subsequent thermal treatment step the lattice structure is fully oxidised again, i.e. the missing oxygen is incorporated into the lattice again.

In this production process of a protective layer on a bipolar plate the resulting microstructure of the protective layer has numerous pores and cracks. Therefore, the protective layer produced in this manner does not have any lasting chromium retention power. Moreover, the physical material properties of the protective layer, in particular its electrical conductivity and the thermal expansion behaviour, are not optimally adapted to the requirements set for a bipolar plate for a fuel cell unit.

### SUMMARY OF THE INVENTION

The object forming the basis of the present invention is to provide a bipolar plate of the aforementioned type, the protective layer of which reliably also reduces chromium evaporation in long-term operation and which also meets the other requirements set for a bipolar plate.

This object is achieved according to the invention with a bipolar plate with the features of the preamble of claim 1 in that one type of metal cation of the oxide system of the protective layer is Fe.

It has been found that the microstructure of the protective layer is improved by the addition of iron (in particular with respect to the reduction of cracks and pores). Therefore, iron has a positive effect on the sintering behaviour of the protective layer. The improved microstructure of the protective layer is an indication that the protective layer is more defect-free. Since the chromium diffusion is based, inter alia, on lattice defects, a lasting chromium retention is assured by a more defect-free protective layer.

Moreover, the addition of iron decreases the coefficient of thermal expansion of the protective layer and therefore causes it to be better adapted to the coefficients of thermal expansion of the other components of the fuel cell unit. As a result, lower mechanical stresses occur during a temperature cycle (heating to operating temperature and cooling) of the fuel cell stack.

In addition, with a protective layer containing iron, a second temperature cycle can be omitted in the sintering process during production of the protective layer. If only a single temperature cycle has to be run (instead of a first temperature cycle for reduction of the protective layer and a second temperature cycle for the subsequent oxidation), then this has a positive effect on production costs and on the microstructure of the protective layer.

The oxide system of the protective layer preferably has a spinel structure.

It is favourable if the oxide system has at least one type of metal cation, the oxide of which is more unstable than chromium oxide (i.e. its stability limit in the Ellingham diagram is higher than the stability limit of chromium oxide).

Moreover, it is favourable if the oxide system has at least one type of metal cation, the oxide of which is more stable than chromium oxide (i.e. its stability limit in the Ellingham diagram is lower than the stability limit of chromium oxide).

Moreover, it is advantageous if a further type of metal cation of the oxide system of the protective layer is Co or Cu.

As a result of the selection of an at least ternary oxide system for the protective layer, an improved microstructure of the protective layer and thus an improved reduction of chromium diffusion through the protective layer and of chromium evaporation can be achieved compared to protective layers comprising only binary oxide systems. Therefore, it is advantageous if the oxide system of the protective layer is an at least ternary oxide system with at least three different types of metal cations.

In a preferred configuration of the invention it is provided that one type of metal cation of the oxide system of the protective layer is Mn.

In a preferred configuration of the invention it is provided that the oxide system comprises Mn, Co and Fe cations.

It has proved particularly favourable if the oxide system has approximately the composition MnCo₂₋ₓFeₓO₄, where 0<x<1.

The oxide system with the approximate composition MnCo_{1.9}Fe_{0.1}O₄ has proved particularly favourable.

Alternatively, it can also be provided that the oxide system of the protective layer comprises Mn, Cu and Fe cations.

The composition of the protective layer of the bipolar plate is preferably selected such that the coefficient of thermal expansion α of the protective layer ranges from approximately 10·10⁻⁶K⁻¹ to approximately 20·10⁻⁶K⁻¹, preferably from approximately 11.5·10⁻⁶K⁻¹ to approximately 13.5·10⁻⁶K⁻¹. Such a coefficient of thermal expansion is adapted particularly well to the thermal expansion behaviour of the other components of the bipolar plate and the fuel cell unit.

The specific electrical conductivity σ of the protective layer preferably ranges from approximately 0.01 S/cm to approximately 200 S/cm.

The bipolar plate according to the invention is particularly suitable for use in a high-temperature fuel cell, in particular an SOFC (solid oxide fuel cell) with an operating temperature of at least 600° C., for example.

The present invention additionally relates to a process for producing a protective layer on a bipolar plate for a fuel cell unit.

A further object forming the basis of the invention is to provide such a process, by means of which a protective layer is produced that also has a favourable chromium retention power in long-term operation and also meets the other requirements to be set for a bipolar plate.

This object is achieved according to the invention by a process for producing a protective layer on a bipolar plate for a fuel cell unit, which comprises the following process steps:
applying a layer of a protective layer starting material to a support layer of the bipolar plate, wherein the protective layer starting material comprises Fe cations;
generating a reduced oxygen partial pressure;
increasing the temperature to a sintering temperature;
subsequently increasing the oxygen partial pressure;
cooling the support layer and the protective layer formed thereon.

By sintering the protective layer in a reducing atmosphere the sintering temperature (usually from 900° C. to 1100° C.) can be reduced (in the range of approximately 750° C. to approximately 800° C.). Moreover, the sintering time (usually 10 hours) can be shortened (to approximately 3 hours at most, for example). As a result of this, production costs can be saved and initial corrosive damages, in particular as a result of a growth of a Cr₂O₃ layer at elevated temperature and an associated lower electrical conductivity, can be reduced. Moreover, this prevents the chromium content in the steel material of the bipolar plate from decreasing too significantly as a result of the growth of a Cr₂O₃ layer and the steel material thus losing its corrosion resistance.

The reducing atmosphere is preferably selected such that at least one of the metal oxides of the oxide system of the protective layer is unstable, so that the associated metal cations have a higher reactivity, whereas the reducing atmosphere is simultaneously selected such that undesirable elements from the starting material of the bipolar plate (in particular chromium) are present in oxidic form. The oxidic form means a higher chemical stability and thus a lower reactivity. As a result, a compaction of the protective layer can occur during the sintering thereof without chromium diffusing therein.

It is favourable if in the first sintering phase the temperature and the oxygen partial pressure are selected such that the state point defined by the sintering temperature and the sintering oxygen partial pressure in the Ellingham diagram lies above the stability limit of chromium oxide, but below the stability limit of at least one metal oxide, the metal cation of which is contained in the protective layer starting material.

It is particularly favourable if the support layer with the starting material is not cooled between increasing the temperature to sintering temperature and increasing the oxygen partial pressure. In this way, the protective layer can be produced in a single temperature cycle without intermediate cooling to room temperature, which has a positive effect on the production costs and the microstructure of the protective layer.

In a preferred configuration of the process according to the invention, the starting material is applied to the support layer using a wet-chemical method.

In this case, for example, the starting material can be sprayed onto the support layer or also applied to the support layer using the screen-printing process.

Further special configurations of the process according to the invention are the subject of claims 16 to 23, the features of which have already been explained above in association with the special configurations of the bipolar plate according to the invention.

Further features and advantages of the invention are the subject of the following description and the diagrammatic representation of exemplary embodiments.

In the drawings:

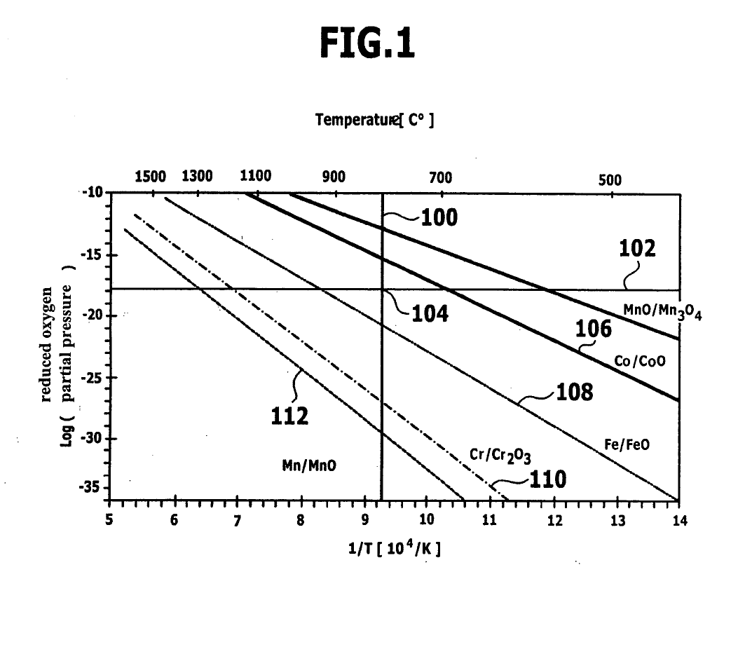

FIG. 1 is an Ellingham diagram, which shows the stability limits of the oxides of chromium, iron, cobalt and manganese according to Ellingham;

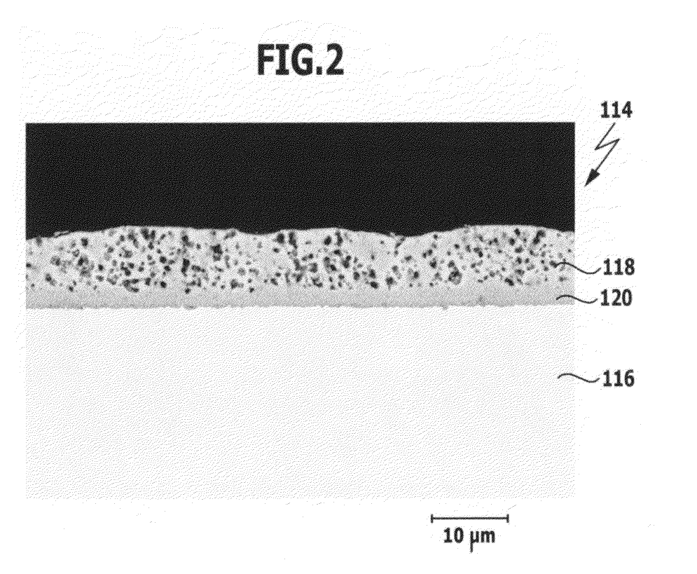

FIG. 2 shows a photomicrograph of a section through a substrate of Crofer22 APU and a protective layer with the composition MnCo_{1.9}Fe_{0.1}O₄, which has been sintered for three hours in a reducing atmosphere at a sintering temperature of 800° C.; and

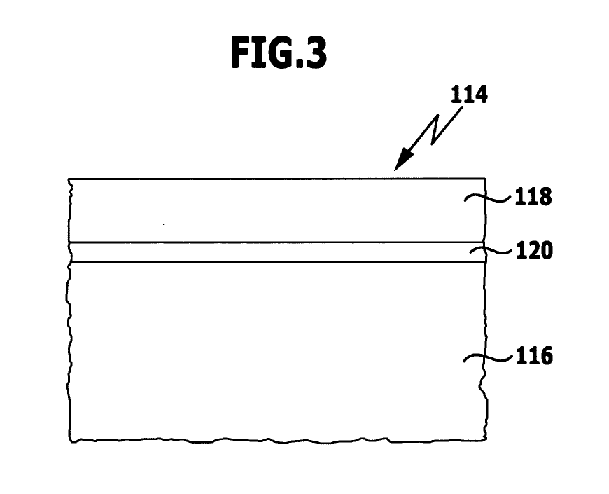

FIG. 3 is a schematic view corresponding to FIG. 2 of a section through a bipolar plate with a protective layer and an intermediate layer arranged between the protective layer and a starting material of the bipolar plate.

To produce the bipolar plate shown in sections in longitudinal section in FIG. 2, the procedure is as follows:

A support layer is provided comprising a ferritic, chromium oxide-forming special steel, e.g. Crofer22 APU special steel, which has the following composition: 22.2% by weight Cr; 0.46% by weight Mn; 0.06% by weight Ti; 0.07% by weight La; 0.002% by weight C; 0.02% by weight Al; 0.03% by weight Si; 0.004% by weight N; 0.02% by weight Ni; the remainder iron.

In a first exemplary embodiment, in a wet spraying process a suspension is sprayed onto this support layer that has the following composition: 1 part by weight of a ceramic powder; 1.5 parts by weight of ethanol; 0.04 parts by weight of a dispersing agent (e.g. Dolapix ET85); 0.1 parts by weight of a binding agent (e.g. polyvinyl acetate, PVAC).

The ceramic powder for the suspension is produced as follows:

Firstly, a quantity of three different metal oxides, e.g. Mn₂O₃, Co₃O₄ and Fe₂O₃, are weighed so that the numerical ratio of the respective metal cations (e.g. Mn, Co, Fe) corresponds to the numerical ratio in the desired composition of the protective layer to be produced (e.g. 1:1.9:0.1 in the composition MnCo_{1.9}Fe_{0.1}O₄).

The weighed metal oxide powders are placed in a polyethylene bottle together with ethanol and ZrO₂ grinding balls (with an average diameter of approximately 3 mm).

In this case, the weight ratio of powder:ethanol:grinding balls amounts to approximately 1:2:3.

The polyethylene bottle is tightly sealed and rotated for 48 hours on a roller bench.

In this case, the rotational speed of the bottle amounts to approximately 250 rpm.

After the said rotation time the grain size of the powder should amount to d₉₀=1 μm.

If the specified grinding period of 48 hours is not sufficient for this, the grinding time must be extended accordingly.

A grain size of d₉₀=1 μm means that 90% by weight of the particles of the ceramic powder have a grain size of 1 μm at most.

After the desired grain size of the ceramic powder has been reached, the ZrO₂ grinding balls are removed from the mixture and the ceramic powder is dried.

The ceramic powder is then calcined at a temperature of 900° C. with a holding time of six hours. In this case, the powder is heated with a heating rate of 3 K/min. and cooled in an unregulated manner after the holding time (natural cooling).

The ceramic powder obtained in this manner is mixed with ethanol, dispersing agent and binder to form the suspension with the aforementioned composition.

The suspension thus obtained is sprayed onto the support layer through a spray nozzle in the wet spraying process.

In this case, the diameter of the nozzle orifice, with which the suspension is atomised, amounts to approximately 0.5 mm.

The spraying pressure, with which the suspension is transported to the nozzle, amounts to 0.3 bar, for example.

The spraying distance of the nozzle from the support layer (substrate) amounts to 15 cm, for example.

The nozzle is moved across the support layer at a speed of 230 mm/s.

The layer of the protective layer starting material is applied to the support layer in two to four coating cycles, i.e. by coating each surface region of the support layer twice to four-times.

Alternatively to the above-described wet spraying process, a screen-printing process can also be used to apply the ceramic powder to the support layer.

For such a screen-printing process a paste is produced, which contains, for example, 50% by weight of the ceramic powder, 47% by weight of terpineol and 3% by weight of ethyl cellulose.

In this case the ceramic powder is produced in the same manner as described above in association with the wet spraying process.

To reduce the required grinding period, 2-4% by weight (based on the weight of the ceramic powder) of a dispersing agent (e.g. Dolapix ET85) can also be added to reach the specified grain size.

The components of the paste are homogenised in a roller frame.

The application of the paste of the protective layer starting material to the support layer of the bipolar plate is then performed by means of a screen-printing assembly known per se to the person skilled in the art.

The support layer with the layer of the protective layer starting material applied using the wet spraying process or screen-printing process, for example, is firstly sintered in a subsequent thermal treatment with a reduced oxygen partial pressure.

For this, the support layer with the protective layer starting material arranged thereon is placed in a sintering oven.

The oxygen partial pressure is then reduced in the sintering oven, e.g. by flushing using a mixture comprising an inert gas (e.g. argon) and 4% mol of hydrogen, for example, which has been previously moistened at a temperature of 25° C., so that the gas mixture has a water content of approximately 3% by weight.

After the oxygen partial pressure has been reduced in the sintering oven in this manner, the oven is heated so that the support layer with the starting material arranged thereon is heated to a sintering temperature of at least approximately 750° C., preferably in the range of approximately 750° C. to 800° C. At this sintering temperature the support layer with the starting material arranged thereon is held in a first sintering phase for a sintering period of approximately 3 hours, for example, as a result of which the layer of protective layer starting material is sintered.

In this case, the reduction of the oxygen partial pressure causes the original spine structure of the sintering additions to break down, as a result of which the reactivity is increased and the associated compaction process of the protective layer is accelerated.

After the sintering period has ended, a changeover occurs to an atmospheric oxygen partial pressure at uniform temperature in order to restore the desired and chemically stable spinel structure of the protective layer in a second sintering phase.

In this case, between the sintering process at reduced oxygen partial pressure and the increase in the oxygen partial pressure to an atmospheric oxygen partial pressure, the temperature of the protective layer or the protective layer starting material is not reduced to a temperature below 750° C.

The reduced oxygen partial pressure during the sintering process amounts to approximately 10⁻¹⁸, for example.

In the Ellingham diagram shown in FIG. 1 the sintering temperature is indicated by the line 100 and the reduced oxygen partial pressure during the first sintering phase is indicated by the line 102.

The intersection point 104 of the lines 100 and 102 identifies the conditions in the first sintering phase.

In the Ellingham diagram this intersection point 104 lies below the stability limit 106 of cobalt, but above the stability limit 108 of iron, above the stability limit 110 of chromium and above the stability limit 112 of manganese.

Therefore, in the temperature and oxygen partial pressure conditions of the first sintering phase, the oxides of iron, chromium and manganese are stable, whereas the oxides of cobalt are unstable. Thus, under these conditions the cobalt cations have a higher reactivity and therefore a higher sintering activity, whereas undesirable elements from the steel of the support layer, in particular chromium, are present in oxidic form. The oxidic form means a higher chemical stability and thus a lower reactivity. As a result, a compaction of the protective layer can occur in the first sintering phase without chromium diffusing into the protective layer.

As a result of the sintering of the protective layer in a reducing atmosphere (because of the reduction of the oxygen partial pressure) during the first sintering phase, the sintering temperature, which usually amounts to 900° C.-1100° C., can be reduced to approximately 750° C. to 800° C. and the sintering time, which usually amounts to 10 hours, can be decreased to approximately 3 hours. As a result of this, costs can be saved in the production of the bipolar plate and initial corrosive damages (degradation) of the support layer and the protective layer, in particular too strong a growth of a chromium oxide layer between the support layer and the protective layer at elevated sintering temperature, can be reduced.

The bipolar plate, given the overall reference 114, obtained after conclusion of the second sintering phase (under atmospheric oxygen partial pressure) and comprising the support layer 116, the protective layer 118 with the composition MnCo_{1.9}Fe_{0.1}O₄ and an intermediate layer 120, which is formed between the support layer 116 and the protective layer 118 and contains cobalt-manganese-iron chromate, is shown in FIG. 3 in a purely schematic view in longitudinal section and in FIG. 2 in a real microscopic view in longitudinal section.

Because of the comparatively low sintering temperature only a little chromium diffuses out of the support layer 116 into the intermediate layer 120, so that an undesirable reduction of the chromium content in the steel of the support layer 116 is prevented.

The microstructure of the protective layer 118 is improved by the presence of iron cations in the starting material of the protective layer 118. In particular, the protective layer 118 only has few cracks and pores.

The iron cations therefore have a positive effect on the sintering behaviour.

The improved microstructure of the protective layer 118, in particular the reduced occurrence of cracks and pores, is an indication that the protective layer is largely defect-free. Since the chromium diffusion is based, inter alia, on the presence of lattice defects, a lasting retention of chromium in the support layer 116 and the intermediate layer 120 is assured by a protective layer 118 that is as defect-free as possible.

As a result of the presence of iron cations in the protective layer 118 its coefficient of thermal expansion α is reduced and therefore it is better adapted to the coefficients of thermal expansion of the steel material of the support layer 116 and to the coefficients of thermal expansion of other components of the fuel cell unit, in which the bipolar plate 114 is to be used. As a result, lower mechanical stresses occur in the fuel cell stack with alternating temperature cycles.

Since the second sintering phase at atmospheric oxygen partial pressure is conducted directly subsequent to the first sintering phase at reduced oxygen partial pressure, no second temperature cycle is necessary in the production of the bipolar plate 116. This has a positive effect on the costs of the production process and on the microstructure of the protective layer 118 of the bipolar plate 114.

The coefficient of thermal expansion α of the protective layer 118 produced in the above-described manner ranges from approximately 10·10⁻⁶K⁻¹ to approximately 20·10⁻⁶K⁻¹.

The specific electrical conductivity σ of the protective layer 118 ranges from approximately 0.01 S/cm to approximately 200 S/cm.

1. Bipolar plate for a fuel cell unit, wherein the bipolar plate comprises a support layer and a protective layer, wherein the protective layer comprises an at least binary oxide system with at least two different types of metal cations, wherein one type of metal cation of the oxide system of the protective layer is Fe.

2. Bipolar plate according to claim 1, wherein one type of metal cation of the oxide system of the protective layer is Co or Cu.

3. Bipolar plate according to claim 1, wherein the oxide system of the protective layer is an at least ternary oxide system with at least three different types of metal cations.

4. Bipolar plate according to claim 1, wherein one type of metal cation of the oxide system of the protective layer is Mn.

5. Bipolar plate according to claim 1, wherein the oxide system of the protective layer comprises Mn, Co and Fe cations.

6. Bipolar plate according to claim 5, wherein the oxide system has approximately the composition MnCo₂₋ₓFeₓO₄, where 0<x<1.

7. Bipolar plate according to claim 6, wherein the oxide system of the protective layer has approximately the composition MnCo_{1.9}Fe_{0.1}O₄.

8. Bipolar plate according to claim 1, wherein the oxide system of the protective layer comprises Mn, Cu and Fe cations.

9. Bipolar plate according to claim 1, wherein the coefficient of thermal expansion α of the protective layer ranges from approximately 10·10⁻⁶K⁻¹ to approximately 20·10⁻⁶K⁻¹.

10. Bipolar plate according to claim 1, wherein the specific electrical conductivity σ of the protective layer ranges from approximately 0.01 S/cm to approximately 200 S/cm.

11. Process for producing a protective layer on a bipolar plate for a fuel cell unit comprising the following process steps:
applying a layer of a protective layer starting material to a support layer of the bipolar plate, wherein the protective layer starting material comprises Fe cations;
generating a reduced oxygen partial pressure;
increasing the temperature to a sintering temperature;
subsequently increasing the oxygen partial pressure;
cooling the support layer and the protective layer.

12. Process according to claim 11, wherein the support layer with the starting material is not cooled between increasing the temperature to sintering temperature and increasing the oxygen partial pressure.

13. Process according to claim 11, wherein the starting material is applied to the support layer using a wet-chemical method.

14. Process according to claim 13, wherein the starting material is sprayed onto the support layer.

15. Process according to claim 13, wherein the starting material is applied to the support layer using the screen-printing process.

16. Process according to claim 11, wherein the starting material comprises at least three different types of metal cations.

17. Process according to claim 11, wherein the starting material comprises Mn cations.

18. Process according to claim 11, wherein the starting material comprises Co or Cu cations.

19. Process according to claim 11, wherein the starting material comprises Ni cations.

20. Process according to claim 11, wherein the starting material comprises Mn, Co and Fe cations.

21. Process according to claim 20, wherein the protective layer produced has approximately the composition MnCo₂₋ₓFeₓO₄, where 0<x<1.

22. Process according to claim 21, wherein the protective layer produced has approximately the composition MnCo_{1.9}Fe_{0.1}O₄.

23. Process according to claim 11, wherein the starting material comprises Mn, Cu and Fe cations.
